(19) United States
(12) Patent Application Publication
(10) Pub. No.: US 2017/0367530 A1
(43) Pub. Date: Dec. 28, 2017

(54) NICKEL-FREE METALLIC COOKWARE WITH GOOD CORROSION PROPERTIES AND THE METHOD OF MAKING THE SAME

(71) Applicant: ENGINEERED MATERIALS SOLUTIONS, LLC, Attleboro, MA (US)

(72) Inventors: Rajesh Ranganathan, Attleboro, MA (US); Brucene LaGreca, Cumberland, RI (US)

(21) Appl. No.: 15/631,374

(22) Filed: Jun. 23, 2017

Related U.S. Application Data
(60) Provisional application No. 62/354,337, filed on Jun. 24, 2016.

(51) Int. Cl. A47J 36/02; C21D 8/02; B32B 15/01

(52) U.S. Cl. CPC A47J 36/02; B32B 15/013; C21D 8/0236

(57) ABSTRACT

The present invention relates generally to a method for producing a multi-layer clad strip for use metallic cookware having a nickel-less cooking surface. In an aspect, the invention relates to a method of using a roll bonding process to generate a nickel-less cooking surface for cookware made of discrete layers of different metals. The nickel-less cooking surface can comprise stainless steel. The stainless steel can include ferritic stainless steel.

### CROSS-REFERENCE TO RELATED APPLICATIONS

This application claims priority to U.S. Provisional Patent Application No. 62/354,337, filed on Jun. 24, 2016, which is relied upon and incorporated herein in its entirety by reference.

### FIELD OF THE INVENTION

The present invention relates generally to a method for producing metallic cookware.

### BACKGROUND

Cookware can be made of various materials, including metallic materials. For example, aluminum, cast iron, carbon steel, copper, stainless steel, and the like have been used in coatings or layers for the cooking surface (i.e., the surface in contact with food). However, there are drawbacks for using these metals in cookware on cooking surfaces. Both cast iron and carbon steel corrode easily, and are hard to clean. Aluminum can leach into a person's food, and has been linked to Alzheimer's disease. Copper is easily dissolvable and can be absorbed into cooked food, which can cause vomiting and diarrhea.

As a result, stainless steels are widely used for the cooking surface of the cookware. Most stainless steels used in commercial and residential cookware are austenitic stainless steels given that they are easily formable and corrosion resistant. Austenitic stainless steel includes some percentage of nickel, which greatly increases the formability of the steel. Stainless steel has many desirable qualities, including anti-corrosion properties, durability, affordability, and deep draw capability.

However, stainless steel cooking surfaces, including austenitic stainless steel, are readily attacked by organic acids, particularly at cooking temperatures. Hot natural salt solutions are one of the severe environments that easily pit austenitic stainless steels, including S304. This type of corrosion releases elements such as iron, chromium and nickel from the cookware itself into the food which can be ingested by the consumer. For example, an austenitic stainless steel such as S304 contains between 8-10% nickel. It has been recognized that exposure to nickel compounds can have adverse effects on human health, among which nickel allergy in the form of contact dermatitis is the most common and well-known reaction.

Therefore, there is a need for developing commercial cookware that includes a stainless steel cooking surface absent of nickel.

### SUMMARY OF THE INVENTION

The present invention relates generally to a method for producing a nickel-less cooking surface in metallic cookware. More particularly, this invention relates to a method of using a roll bonding process to generate a nickel-less cooking surface for cookware made of discrete layers of different metals. In an aspect, the invention is directed at a nickel-less cooking surface having good corrosion properties. The cooking surface can comprise stainless steel.

In an aspect, the invention is directed at a method for creating a multi-layer clad strip for metallic cookware with a cooking surface, the method comprising selecting a first metallic material, wherein the first metallic material is essentially nickel-free, selecting a second metallic material to be bonded to the first metallic material and bonding the first and the second metallic materials to one another, wherein the first metallic material is positioned to be the cooking surface for the metallic cookware. In an aspect, selecting the first metallic material comprises selecting a nickel-free stainless steel. The nickel-free stainless steel can have a sufficient corrosion resistant characteristic. In an aspect, the stainless steel is selected from stainless steel having a PREN higher than 10. In some instances, the stainless steel has a PREN higher than 18. In other aspects, the stainless steel has a PREN higher than 24. The stainless steel can comprise a ferritic stainless steel.

The method of making the multi-layer clad strip can also include selecting a third metallic material to be bonded to the second metallic material, wherein the bonding further comprises bonding the third metallic material to the second metallic material opposite the first metallic material. In an aspect, the second metallic material is selected from metals that have good thermal properties and the third metallic material is selected from a metal that is rigid. In an aspect, the second metallic material can comprise copper, titanium, or aluminum. In an aspect, the third metallic material comprises stainless steel. The multi-layer clad strip can be cold roll bonded.

In an aspect, the invention is directed at a multi-layer clad strip for use in metallic cookware having a nickel-free cooking surface, the multi-layer clad strip comprising a first layer comprising a nickel-free stainless steel for the cooking surface and a second layer comprising a second metal different from the nickel-free stainless steel of the first layer. In an aspect, the nickel-free stainless steel is ferritic stainless steel. In some aspects, the ferritic stainless steel has a PREN higher than 18.7. In an aspect, the ferritic stainless steel is S444.

In an aspect, the second metal of the multi-layer clad strip has a better heat distribution compared to the first layer. In other aspects, the second metal is lighter than the stainless steel of the first layer. In another aspect, the multi-layer clad strip has a third layer comprising a third metal different from the metal of the second layer, wherein the second layer is configured to form a core of the multi-layer clad strip. The third metal can be stainless steel.

These and other aspects of the invention can be realized from reading and understanding of the detailed description and the figures.

### BRIEF DESCRIPTION OF THE DRAWINGS

FIG. 1 illustrates a schematic representation of a roll bonding operation according to an aspect of the present invention.

FIGS. 2-3 illustrate schematic representations of multi-layer components made of multiple metallic materials according to an aspect of the present invention.

### DETAILED DESCRIPTION OF THE INVENTION

A new process for creating metallic cookware with a nickel-free cooking surface is described herein. The present invention is directed at a method for producing a nickel-free cooking surface for metallic cookware, and the product produced therein.

In an aspect, the cookware is formed from a multi-layer clad strip. The clad strip used to make the metallic cookware is formed from a plurality of metallic materials, wherein the multi-layer clad strip includes a top layer made for a cooking surface that is free of nickel and at least one another layer of metallic material. In such instances, the cooking surface needs to be corrosion resistant that does not easily corrode under common cooking acids/bases and salts. In one aspect, the cooking surface is formed from stainless steel. In such aspects, the stainless steel cooking surface is formed absent of nickel (i.e., nickel-less stainless steel).

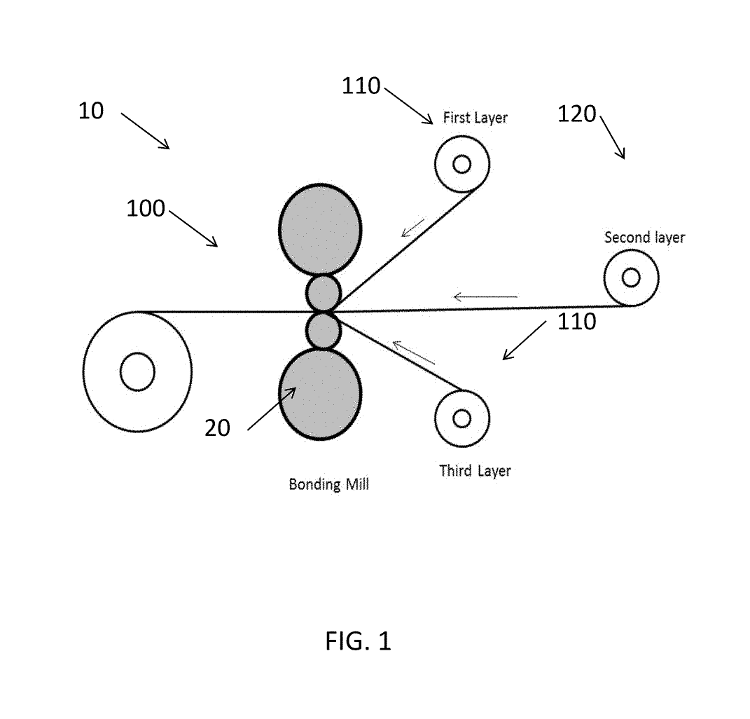

In an aspect, a roll bonding process 10 (see FIG. 1) is used to generate a multi-layer clad strip 100. As discussed above, the multi-layer clad strip 100 includes at one layer of nickel-free metal 110 (first layer) used for the cooking surface, and at least one other metal 120, 130 (second and third layers) to form additional layers in the multi-layer clad strip 100. In an aspect, the multi-layer clad strip 100 includes at least one layer of stainless steel 110 that does not contain nickel with at least one other layer of material. In some aspects, more than two layers can be utilized to form the multi-layer clad strip. For example, as shown in FIG. 1, three layers of metallic material 110, 120, 130 are bonded together. In an aspect, the bonding can be performed by a bonding mill 20. Bonding can include, but is not limited to, cold roll bonding, warm roll bonding, and hot roll bonding, and various other cladding methods known in the art. In this example, the first layer 110, intended to be the cooking surface, is nickel-free. In an aspect, the nickel-free material is considered to be nickel-free if it contains less than approximately 0.5% nickel.

In an exemplary aspect, the first layer is a nickel-free stainless steel 110. In such instances, the nickel-free stainless steel 110 can have a sufficient corrosion resistant characteristic. The type of nickel-free stainless steel 110 can be selected based upon its Pitting Resistance Equivalent Numbers (PREN). The higher the PREN, the better the corrosion characteristic of the stainless steel. Using the PREN of the stainless steel allows the correct stainless steel to be selected based upon the application. That is, if the cookware is going to be used in very corrosive conditions, a stainless steel with a high PREN will be selected. In cases where corrosion is not an issue, the PREN of the stainless steel does not need to be as high.

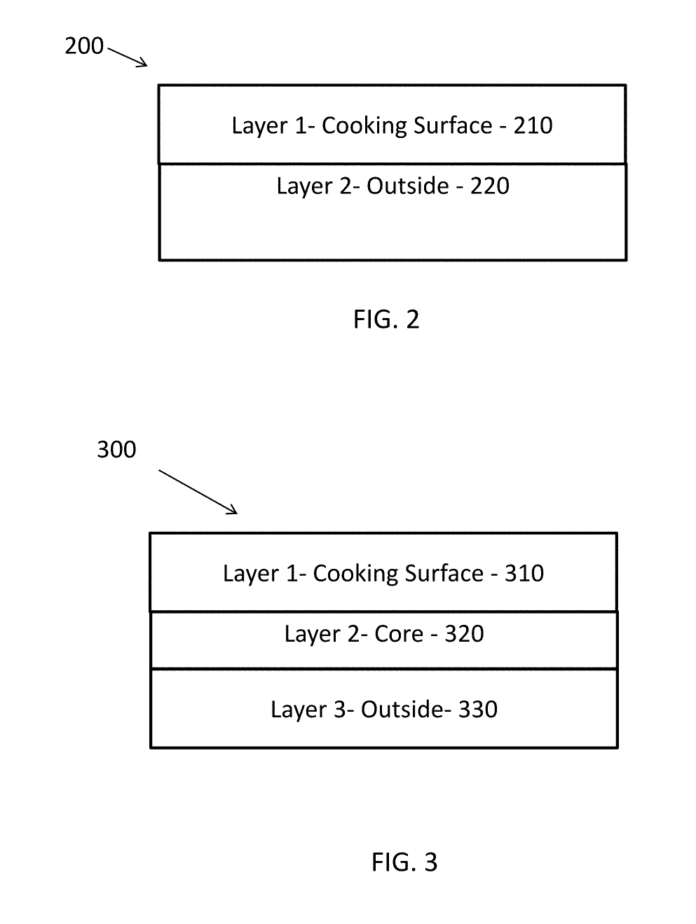

In an aspect, the first layer 110 is a ferritic stainless steel. Ferritic stainless steel can be used as the cooking surface of the metallic cookware because it is essentially nickel-free in comparison to austenitic, martensitic, and other types of stainless steel. These types of stainless steel contain a higher amount of nickel when compared to ferritic stainless steel. The other layers 120, 130 (i.e., second and third layers) of the metallic clad strip 100 can be of various other materials commonly used in metallic cookware. For example, the core layer 120 can be aluminum and/or copper for good thermal properties, and the external non-cooking surface 130 can be stainless steel and/or copper for rigidity and appearance purposes. While FIG. 1 illustrates a multi-layer clad strip 100 comprising three layers 110, 120, 130, other embodiments can form a multi-layer clad strip having various numbers of layers. For example, there can be one, two (FIG. 2), three (FIG. 3), four, or more layers. However, the cooking layer 110 of the multi-layer clad strip 100 needs to be comprised of a nickel-free metal. In an aspect, the cooking layer comprises nickel-free stainless steel.

In an aspect, the selection of the type of stainless steel for the cooking surface is performed on the basis of PRENs combined with the amount of nickel found in the stainless steel. The PREN gives a basic pitting and corrosion resistance for different stainless steels. The higher the PREN, the more resistant the stainless steel is to corrosion. After selecting a PREN number, a stainless steel with very low amount of nickel can be selected. In an aspect, after ensuring the stainless steel has less than 0.5% Ni, a stainless steel with a PREN higher than S304 is selected, as shown in Table 1. By picking a stainless steel having no nickel and with a high PREN number generally assures a better corrosion performance than the universally used S304 stainless which usually pits in a hot salt water environment and leeches nickel. In an aspect, stainless steels with low PRENs and essentially nickel free can be chosen, as long as the corrosion level is not an essential function for the resulting material.

Referring to Table 1, S304 contains approximately 18.1% by weight chromium, no Molybdenum, 8.4% nickel, and 0.04% nitrogen, with a PREN of 18.7. S316 has a higher PREN (24.2) but has nickel over 10%. In comparison, the ferritic stainless steels all have essentially no nickel. S409 has a PREN of 11.7, S430 has a PREN of 16.7, and S444 has a PREN of 25. Other stainless steels than those discussed above and shown in Table I can be selected for the cooking surface, but it preferred that the stainless steel have a high PREN and essentially no nickel.

TABLE 1
PREN numbers for some standard stainless steel materials

| Type | Metal | Cr | Mo | Ni | N | (PREN) |
|---|---|---|---|---|---|---|
| Austenitic | 304 | 18.1 | 0 | 8.4 | 0.04 | 18.7 |
| Austenitic | 316 | 16.5 | 2.15 | 10.2 | 0.04 | 24.2 |
| Ferritic | 409 | 11.5 | 0 | 0 | 0.01 | 11.7 |
| Ferritic | 430 | 16.5 | 0 | 0 | 0.01 | 16.7 |
| Ferritic | 444 | 17.7 | 2.1 | 0 | 0.02 | 25.0 |

In an aspect, the other layer(s) (i.e., layers other than the cooking surface) of the multi-layer clad strip can include any metal. In an exemplary aspect, the other layers can include copper (Cu) or aluminum (Al) to increase thermal properties and/or to make lighter-weight cookware. In an aspect, the multi-layer strip can include at least one layer of nickel-free stainless steel for the cooking surface along with multiple layers of core metal surrounded by another stainless steel layer meant to be the outer layer to add to the sturdiness and appearance of the cookware. In an aspect, the core metal can include both Aluminum and Copper with another stainless steel on the outer layer. The outer non-food contact layer of stainless steel does not necessarily need to be nickel-free, but it is desirable that the stainless steel contain the least amount of nickel as possible.

Cladding the multiple layers together and forming cookware with the nickel-free stainless steel on the inside of the vessel (cooking surface) creates a cookware that has a nickel-free cooking surface with higher corrosion resistance. For example, FIGS. 2 and 3 show two multi-layer clad strips 200, 300 respectively where the cooking surface (Layer One) 210, 310 is a nickel-free stainless steel. However, one of the multi-layer clad strips 200 only has two layers, with the cooking surface (Layer One) 210 and an outside layer (Layer Two) 220. The other strip 300 has three layers, a cooking surface (Layer One) 310, a core layer (Layer Two) 320, and an outer layer (Layer Three) 330. Such a system does not need to be balanced on Layer One 310 and layer Three 330. Layer Three 330 can be thicker or thinner than Layer One 310 and can also be of a different grade of stainless steel, such as austenitic, etc. The primary function of the core layer 320 is improved heat distribution compared to stainless steel and/or weight lightening. The core layer 320 can be but not necessarily limited to aluminum, copper, or multiple layers of aluminum and copper, titanium etc. In an aspect, the characteristics of desirable outside layer materials include deep drawability, magnetizable for induction compatibility, and appearance, all qualities that stainless steel, steel, copper, aluminum and the like include.

Having thus described exemplary embodiments of a method to produce metallic composite material, it should be noted by those skilled in the art that the within disclosures are exemplary only and that various other alternatives, adaptations, and modifications may be made within the scope of this disclosure.

What is claimed is:

1. A method for creating a multi-layer clad strip for metallic cookware with a cooking surface, comprising:
a. selecting a first metallic material, wherein the first metallic material is essentially nickel-free;
b. selecting a second metallic material to be bonded to the first metallic material; and
c. bonding the first and the second metallic materials to one another, wherein the first metallic material is positioned to be the cooking surface for the metallic cookware.

2. The method of claim 1, wherein selecting the first metallic material comprises selecting stainless steel, wherein the stainless steel is nickel-free.

3. The method of claim 2, wherein the stainless steel has a sufficient corrosion resistant characteristic.

4. The method of claim 3, wherein the stainless steel is selected from stainless steel having a PREN higher than 10.

5. The method of claim 4, wherein the stainless steel has a PREN higher than 18.

6. The method of claim 5, wherein the stainless steel has a PREN higher than 24.

7. The method of claim 2, wherein the stainless steel comprises a ferritic stainless steel.

8. The method of claim 1, further comprising selecting a third metallic material to be bonded to the second metallic material, wherein the bonding further comprises bonding the third metallic material to the second metallic material opposite the first metallic material.

9. The method of claim 8, wherein the second metallic material is selected from metals that have good thermal properties and the third metallic material is selected from a metal that is rigid.

10. The method of claim 9, wherein the second metallic material comprises copper or aluminum.

11. The method of claim 10, wherein the third metallic material comprises stainless steel.

12. The method of claim 1, wherein the bonding comprises cold roll bonding.

13. A multi-layer clad strip for use in metallic cookware having a nickel-free cooking surface, the multi-layer clad strip comprising:
a. a first layer comprising a nickel-free stainless steel for the cooking surface; and
b. a second layer comprising a second metal different from the nickel-free stainless steel of the first layer.

14. The multi-layer clad strip of claim 13, wherein the nickel-free stainless steel is ferritic stainless steel.

15. The multi-layer clad strip of claim 14, wherein the ferritic stainless steel has a PREN higher than 18.7.

16. The multi-layer clad strip of claim 14, wherein the ferritic stainless steel is S444.

17. The multi-layer clad strip of claim 13, wherein the second metal has a better heat distribution compared to the first layer.

18. The multi-layer clad strip of claim 17, wherein the second metal is lighter than the stainless steel of the first layer.

19. The multi-layer clad strip of claim 17, further comprising:
c. a third layer comprising a third metal different from the metal of the second layer, wherein the second layer is configured to form a core of the multi-layer clad strip.

20. The multi-clad strip clad strip of claim 19, wherein the third metal comprises stainless steel.
